(19) United States
(12) Patent Application Publication
(10) Pub. No.: US 2009/0144816 A1
(43) Pub. Date: Jun. 4, 2009

(54) Knowledge-Intensive Arrangement for Handling of Scattered Data

(76) Inventors: Balan Pillai, Helsinki (FI); Veli Matti Pyykkonen, Riihimaki (FI); Vesa Salminen, Espoo (FI)

Correspondence Address: BIRCH STEWART KOLASCH & BIRCH, PO BOX 747, FALLS CHURCH, VA, 22040-0747, US

(21) Appl. No.: 12/084,690

(22) PCT Filed: Nov. 6, 2006
(86) PCT No.: PCT/FI2006/050479

§ 371 Date: Dec. 9, 2008

(30) Foreign Application Priority Data
Nov. 9, 2005 (FI) 20051139

(51) Int. Cl. G06F 21/00

(52) U.S. Cl. 726/11

(57) ABSTRACT

The invention relates to a knowledge-intensive arrangement (1) for handling of scattered data, said arrangement comprising at least devices (3-12, 44) interconnected via a network and provided with different properties and operating systems. The arrangement (1) comprises at least a communication means (2, 2a) conjectable to at least one of the devices (3-12, 44), said communication means (2, 2a) being provided with at least a communication element (14) for setting up a connection. The eommunieation means (2, 2a) has Been adapted to identify the user of the communication means (2, 2a) and, upon acceptable accomplishment of identification, to establish a verified and protected connection via the communication means (2, 2a) to the other devices (3-12, 44) connected to the arrangement (1).

The present invention relates to a knowledge-intensive arrangement for both real-time and browser-based handling of scattered data as defined in the preamble of claim 1.

The present invention mainly concerns an arrangement that enables data and knowledge already existing in different sources or new data produced as necessary to be utilized in different processes. In this context, data refers to any data consisting of units of measurement of different quantities, such as pressure values, temperatures, current intensities or corresponding data as well as verbal, pictorial or numeric information. Correspondingly, knowledge-based information refers here to combined information that is available from experts in any specific field or e.g. from sophisticated artificial intelligence applications. In the following, all information and knowledge utilized according to the invention will be referred to by the common designation ‘data’. Most of this data to be handled consists of conceptualized, semantic data. According to the invention, the above-mentioned existing data scattered in different sources or new data produced as needed is collected together by using suitable means and the data thus obtained is utilized to improve a process and to maintain, promote and control an activity. ‘Collecting together’ here does not refer to collecting and storing the data in one place but to utilizing the data while the data itself remains where it was before.

A problem in prior-art solutions is often how to obtain at the right time correct data useful for the course of a process. One reason for this are the many compatibility problems between different systems and processes. The consequences of these problems include an inoperational condition or incorrect operation of devices, systems and processes as well as retarded and hampered operation of many processes.

The object of the present invention is to overcome the above-mentioned drawbacks and to achieve a knowledge-intensive arrangement for the handling of scattered data that is reliable in operation and well compatible with different environments. A further object is to create a communication means allowing the above-mentioned handling of data which can be safely and compatibly connected to many different bases and which enables a safe as well as verified and protected connection to scattered sources of data. The arrangement of the invention is characterized by what is presented in the characterization part of claim 1. Other embodiments of the invention are characterized by what is disclosed in the other claims.

The solution of the invention has the advantages of fast utilization of all essential data in a secured manner in respect of data security and—thanks to compatibility and reliable communication channels—good connections to many different data sources of different formats. Due to the good and safe connection possibilities and the efficiency achieved via grid processing, the arrangement allows e.g. real-time execution of applications requiring high computing power. For example, this arrangement enables three-dimensional modeling of prototypes in innovation or product development projects without actual production of the proto-types.

In the following, the invention will be described in detail by referring to a few embodiment examples and the attached drawings, wherein

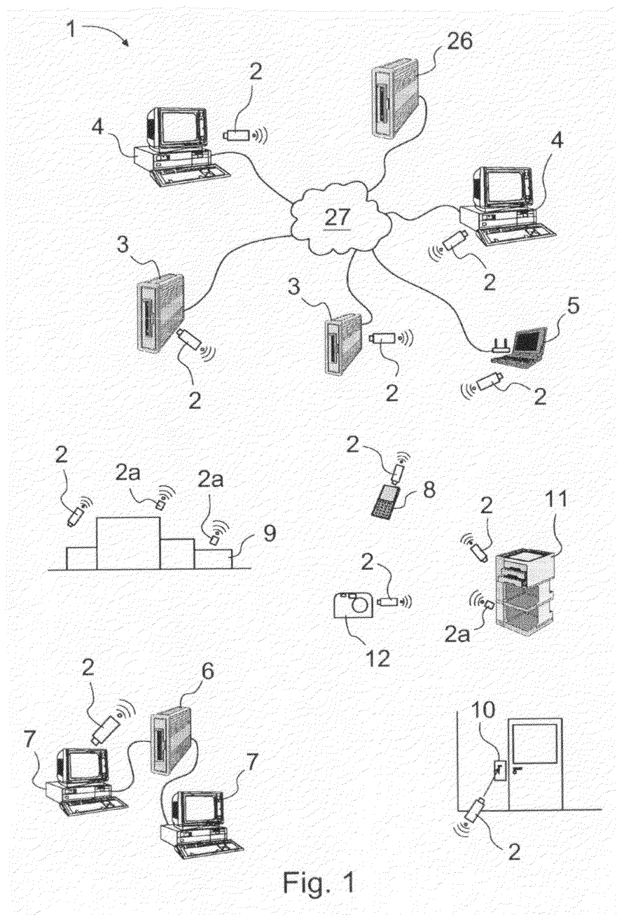

FIG. 1 presents a diagram representing an arrangement according to the invention, comprising the most essential elements,

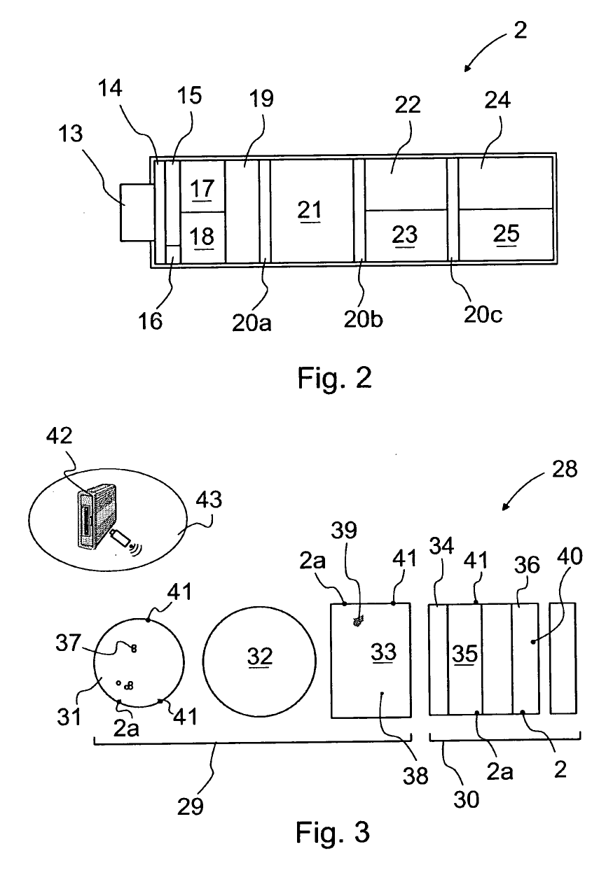

FIG. 2 presents a simplified diagram of a communication means according to the invention,

FIG. 3 presents a simplified process flow diagram representing a paper-making process run on a paper machine where the arrangement of the invention is applied, and

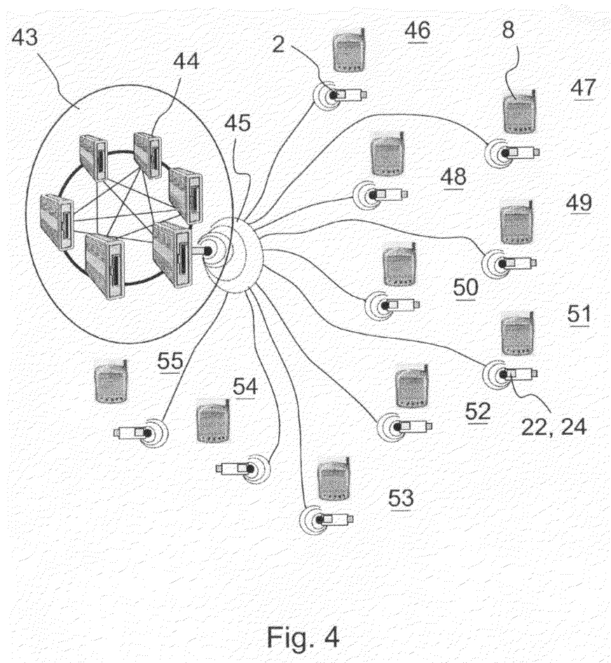

FIG. 4 presents a simplified process flow diagram representing an innovation process where the arrangement of the invention is applied.

FIG. 1 is a diagrammatic representation of an arrangement 1 implementing the idea of the invention, comprising the most important elements. Essential elements of the invention are a communication means 2, 2a establishing a verified, identified and protected connection, and different devices 3-13 connected to the arrangement via the communication means. Via the communication means 2, 2a, preferably a wireless connection is set up, but a wired connection can also used where necessary. The communication means indicated by reference number 2 is a detached component which can be connected to different bases in different environments, e.g. to servers 3 and computers 4 used as terminals or equivalent and connected to a public network 27, such as the Internet, or to portable computers 5, which may be connected to the public network 27 via a wired or wireless connection or which may also be stand-alone devices. In addition, the communication means 2 can be connected to intelligent phones 8 and PDA devices or equivalents, which are connected via a wireless connection to the public network 27 or which may also be stand-alone devices. The communication means 2 can also be connected to private networks, which may include servers 6 and work stations 7 connected to each other and used e.g. in a company's own closed network. In this case, it is sufficient to connect one communication means 2 to one of the devices 6 or 7 in the private network. Likewise, the communication means 2 can be connected to industrial process machines or equipment 9, or to any device provided with a suitable connector, such as a USB connector. The detached communication means 2 can also be used as an intelligent company key, in which case, when the communication means 2 serving as a company key is to be used, it is inserted into an access control device 10 provided with a suitable connector.

Similarly, a communication means indicated by reference number 2a, corresponding to communication means 2, is preferably integrated in different office machines 11, such as copiers or printers, or in domestic appliances and corresponding devices, or also e.g. in a portable telephone. A communication means 2a may also be integrated in industrial process machines 9 in many different placements and it can be used besides a detached communication means 2.

FIG. 2 presents simplified diagram of the structure of a detached communication means 2 implementing the idea of the invention. The integrated communication means 2a corresponds in basic structure to the detached communication means 2, but at least it has no connector as the detached communication means has for connection to different devices 3-12.

Communication means 2 is provided with a connector 13, such as a USB connector, by means of which the communication means 2 is connected to different devices 3-12. In addition, the connector 13 is connected to a communication element 14 contained in the communication means 2 and suitably consisting of e.g. a UWB (ultra wide band) chip, which allows wireless communication in a UWB network between the device connected to the communication means 2 and the external world.

Placed after the communication element 14 in the communication means 2 is a so-called first level firewall 15, which comprises a XIP identifier, a firewall, IP tunneling and virus detection as well as virus elimination functions. Moreover, the communication means 2 contains a localization element 16, such as a GPS chip or a localization element employing some other localizing technique. In conjunction with the localization element 16, the communication means contains a grid module 17 enabling distributed grid processing and a user identification module 18, which contains biometric identification, presence detection and personalization functions, among other things. In connection with the present invention, the term “user” refers both to a person using the communication means 2, 2a and e.g. to an industrial process installation 9 in which the communication means has been connected to monitor processes. The term “user” also refers to the function of the communication means 2, 2a according to its role and placement in cases where the communication means is placed e.g. in a process installation 9 to monitor, supervise, regulate and control the course of the process.

In conjunction with the grid module 17 and the user identification module 18, the communication means additionally contains at least a FLASH component 19 serving as a virtual memory, which has been fitted to be activated when the communication means 2 is connected via its connector 13 to a suitable peripheral device 3-12. The data contained in the memory in conjunction with the FLASH component 19 can be retrieved very quickly for utilization. The speed of data retrieval is of the order of nanoseconds. Placed behind the FLASH component 19 is a second firewall 20a, which protects in the communication means 2 an algorithm module 21 consistent with the AES standard (Advanced Encryption Standard), said module containing several embedded and cross-linked program codes adapted e.g. to verify the correctness and validity of the identifications performed by the user identification module 18. Correspondingly, for example in industrial process applications, the program codes of the algorithm module 21 have been adapted specifically in each case to monitor, regulate and control various reactions and occurrences taking place in the process. In this case, the algorithm modules 21 of the communication means 2, 2a are tailored separately for each case. When used for any purpose whatsoever, the algorithm modules 21 have been tailored to suit the purpose in question.

In addition, via the algorithm module 21, all existing standards and corresponding definitions are interconnected so as to render them mutually compatible, so that the algorithm module 21 effectively monitors the validity and permissibility of the connections and data retrievals effected via the communication means 2, 2a. The algorithm module 21 is provided with biochemical surface treatment such that, if the algorithm module chip is removed from its mounting base, it will be immediately destroyed and disintegrated into a powdery substance. This makes it impossible to detach the algorithm module 21 and e.g. to attempt to decipher its content. Immediately behind the algorithm module 21 is a third firewall 20b, which together with the second firewall 20a allows very reliable protection of the algorithm module 21. Behind the third firewall 20b are a shared data storage 22, which consists of shared memory used in common, and a local data storage 23. In the shared data storage 22, data of-the external devices 3-12 are visible in real time, for example allowed data of other computers having a communication means 2 connected or data of other devices 9, 11 having an integrated communication means 2a, such as copying machines or equivalent. In general, the data visible in the shared data storage 22 are not permanent but are only usable for a given time span. Visible in the local data storage 23 are data of the device to which the communication means 2, 2a is connected.

Behind the data storages 22 and 23 there is further a fourth firewall 20c, behind which are a hologrammatic model storage 24 containing acquired knowledge and a learning algorithm module 25, which makes it possible to detect frequently repeated data and to acquire information on the basis of it, the information thus acquired being stored in reflected form into the hologrammatic model storage 24. The learning algorithm module 25 has been adapted to cooperate with the algorithm module 21.

The above-mentioned components 13-25 of the communication means 2 are mutually interconnected so that the cooperation between all the components is mutually enhancing and enables effectual operation of the communication means 2. A detached communication means 2 receives the required operating current via its connector 13 from the device 3-12 to which the communication means 2 is connected. Similarly, an integrated communication means 2a has been arranged to receive its operating current directly from the device 9, 11 to which it is connected.

The most important basic features of the arrangement of the invention include: a decentralized network machine and user devices 3-12; a good system compatibility; personalization, verification and user identification; use of a view without actual data transfer; multi-channel communication mode; utilization of low frequencies in a UWB network and scattered data processing, i.e. data processing based on the grid principle. These basic features form a framework that makes it possible to manage and control different processes by means of the devices 3-12 connected to the arrangement 1 and their semantic data storages 43, servers and other functions.

The network machine functioning as the coordinator of the arrangement 1 consists of a plurality of database machines and computers located in different parts of the country or the world, which have been adapted for use by the arrangement and which together contain the required means and software for the control and management of the arrangement. The network machine concept conforms to the situation and is therefore not always one and the same structure consisting of the same machines operated in a network. The network machine is a decentralized system working in a plurality of machines connected to the arrangement, e.g. servers 3 and database machines, but due to the grid processing typical of the arrangement, the functions of the network machine are perceived by the user as a single function. The network machine contains means at least for issuing user identifications, taking care of the required verification and profiling functions and for monitoring and verifying the validity and permissibility of the functions of the arrangement. Moreover, the network machine contains means for controlling, estimating, managing and carrying through the processes to be executed in the arrangement. These means comprise, in addition to the various regulating elements and communication means, suitable process protocols, among other things.

The arrangement of the invention comprises scattered devices mainly connected to each other via communication means 2, 2a over wireless links or, if necessary, wired links, such as servers and database computers 3 and 6, computers 4 and 7 used as workstations, portable computers 5 and intelligent phones 8, telephones, PDA devices or equivalent, and office machines 11, equipment 9 performing industrial processes and also various other devices, such as cameras 12, vehicles, domestic machines, access control devices 10, etc. By connecting a detached communication means 2 to any office machine 11 provided with a USB connector or equivalent and serving as an output device, it is possible to output a desired data file via the output device by using the communication means 2 without the help of a computer. Similarly, from a camera 12 provided with a USB connector, images or video clips can be transferred to a computer, or images can be output directly via an output device.

The algorithm module 21 of the communication means 2, 2a is also provided with means that make it possible to transfer the user's own electronic mail from an electronic mail server to the virtual memory of the communication means and back to the server by only connecting the communication means 2, 2a to a device 3-12 used as an aid and having an operating system recognized by the communication means. The data are transferred between the server and the communication means 2, 2a in such a way that the data transferred or viewed leave no trace in the device 3-12 used as an aid. Electronic mail can be read and written in off-line mode, and the data transfer can also be performed without an on-site Internet connection as the connection is implemented via a UWB network. In addition, the communication means 2, 2a has been adapted to identify substantially all electronic mail protocols and to understand new updated software versions and to automatically execute the required updates. Attachments in a different format are also opened via the communication means.

The arrangement 1 may additionally also comprise devices 26 that have no communication means 2 or 2a but that communicate with public or private networks in other ways. According to the arrangement, these devices 26 can be operated from devices 3-12 provided with communication means 2 or 2a, but in devices 26 the data are not as well protected as in the devices 3-12 provided with communication means. Like-wise, the data and databases on the devices 3-12 provided with communication means 2, 2a can not be directly accessed from devices 26.

System compatibility is achieved by using a connector 13, such as a USB connector, provided with facilities allowing the communication means 2 to be connected to different devices 3-12 provided with a corresponding connector, so that when the communication means 2 is connected to a device, the connector 13 identifies the operating system of the device 3-12 and simultaneously activates the first level firewall 15. Thus, regardless of the operating system of the device, the device 3-12 and the communication means 2 identify each other and communication between the device and the communication means 2 is possible. The aforesaid facilities include e.g. a suitable software package embedded in conjunction with the connector 13.

Personalization, verification and user identification are implemented in the user identification module 18 comprised in the communication means 2, 2a, which module uses the memory provided in conjunction with the FLASH component 19 as its memory storage. When a new communication means 2, 2a is connected for the first time to the arrangement 1 via one of the devices 3-12, the arrangement asks for profile data of the user of the communication means 2. Via the user interface of the device, the user inputs into the arrangement 1 his/her/its own profile data and the data required for personalization, which may consist of e.g. information regarding the person's professional skill, job, rights within his/her own company, etc. These data remain in memory in the decentralized network machine of the arrangement 1, where they can be checked every time when the person in question establishes connection via his/her communication means 2 to one of the devices 3-12. The person's connection is verified via biometric identification, whereby e.g. the person's own magnetic field is measured. Other identification methods, such as iris identification, are also used to verify a person's identity. After the person has been identified, his/her personalization data are transmitted into the arrangement 1, which is thus informed that the person having the profile in question has logged in to the arrangement and is present in a given place. The arrangement 1 comprises means for storing presence data into the arrangement, on the basis of which data the arrangement knows very exactly what the person in question has done within the arrangement 1 and when.

A further feature of the arrangement 1 of the invention is the use of a view without actual transfer of digital data. Thus, using the device to which the communication means 2 is connected, it is possible to obtain information from data-bases and memory storages allowable on the basis of personalization within the entire network connected to the arrangement. It is also possible to see as a view e.g. a prototype of a new product, three-dimensional modeling of which is performed on the principles of grid processing on computers connected to the arrangement.: Such data, a three-dimensional model or equivalent, is shown on the display of the device as a special view, which cain not be copied. Thus, the data is available for use, but it can not be copied as such.

The multi-channel communication mode which is characteristic of the arrangement here means that the system enables the transmission, collection and further transfer of data in many different formats, such as images, texts, data, video clips, news bulletins, etc. within the arrangement so that the required multi-format data is always available for use e.g. at different stages of a given project. Related to the multi-channel communication mode is also the circumstance that, in the arrangement, communication between different operating systems and programs takes place in such manner that the arrangement automatically takes care of the required conversions, so the user him/herself need not be aware of data being obtained from different operating systems and programs. To allow the aforesaid functions, the basic database in the decentralized network machine contains means, e.g. in the form of a suitable software module, for processing data moving in the arrangement by receiving data related to each context, such as a given project, converting it to a format suitable for the arrangement and transferring the data further to the user.

Thanks to the multi-channel processing, for example when the same industrial process is to be controlled and monitored, a process device, e.g. a paper machine can receive data in many different formats from many different sources. Similarly, a process device can send data in many different formats to many different sources. Such data may consist of simple regulating parameters for a controlling computer or e.g. messages to individual persons or groups, such as special experts, who can respond with a solution to a problem in the process that the control computer is unable to solve alone.

Correspondingly, in project work, persons involved in the same project can work as a geographically decentralized team and perform different tasks in a role-based manner to further the project. Having connected the communication means 2 to a computer in any location, a person involved in the project is immediately ready to read multi-format data communicable in the project and to produce new data in any form for use in the project. The arrangement takes care of project-specific collection and display of data to persons involved in the project and to other parties entitled to the same information.

In the arrangement, the various devices 3-12 are connected together via communication means 2, 2a to a world-wide wireless network, such as a low-frequency UWB network allowing a service range of several kilometers and formed by signals passing through buildings. Thus, the physical location of an individual device 3-12 is not decisive and the operating costs of the connections are insignificant or very low. Comprised in the arrangement is also a wired network where needed, as mentioned above.

In addition, the grid module 17 and shared data storage 22 contained in the communication means 2, 2a have been adapted to cooperate in such manner that communication in the arrangement 1 takes place in accordance with the previously mentioned so-called grid principle. It is therefore not important which route is taken from a given device to access 5 the desired data, which may be stored on one or more machines or devices 3-12 in the arrangement 1. Likewise, the aforesaid three-dimensional modeling or other function requiring large-scale computing is executed using a plurality of machines or devices 3-12 in different parts of the arrangement 1.

The arrangement additionally comprises a so-called pool, which consists of different professional groups, to whom it is possible to deliver matters having reached a given state of readiness for further treatment. Use of the pool is only possible via communication means 2. An example of the use of a pool is estimation of the goodness of an invention and its modeling. However, the user of a given device can not see through the network whether his/her case has been treated by an expert group.

Use of the arrangement of the invention in a papermaking process is implemented e.g. by placing communication means 2, 2a according to the invention, modified to suit the process run on the paper machine, in required positions in the paper machine with respect to control of the process. FIG. 3 presents a simplified process diagram of a papermaking process run on a paper machine 28. In this solution, the process starts from a pulp section 31, where the fibrous pulp is treated by adding to it required chemicals and mixing the fibrous pulp so as to make it as homogeneous as possible. The fibrous pulp is moved through a headbox 32 onto a wire 33, from where the fibrous pulp is passed via a press section 34 e.g. to a coating station 35 and further via an intermediate calender 36 onwards. The pulp section 31, headbox 32 and wire 33 mainly constitute the wet section 29 of the paper machine 28. Correspondingly, the part following the press section is called the drying section 30 of the paper machine.

The papermaking process involves problems due to many kinds of non-linearities, which are difficult to measure and have an effect at various points along the process on the quality of the paper produced. Due to the drawbacks of linear control as used at present, defects in quality are generally only detected at the output end of the paper machine, so when serious defects in quality occur, the whole finished roll must be returned into the process. This is very expensive and impairs the capacity of the paper machine. Defects in quality are caused e.g. by the deposit and gas bubbles produced in the mixing process and by various substances present in the pulping section 31, such as the resin in the wood material or other impurities causing different chemical reactions. Among other things, the process produces so-called supra-molecular reactions 37, which result in various small holes or dots 38 or material agglomerations 39 appearing in the fibrous layer and visible in the finished paper as different shadows.

Similarly, after the glue press in the coating station 35 of the drying section 30, impurities caused by so-called supra-molecular reactions may be formed on the surface of the paper web. Those impurities drift to the surface of the rolls in the drying section, where in unfavorable conditions the impurities accumulate as small blisters 40 on the roller surfaces, impairing the quality of the paper produced. If the blisters can not be removed by washing, then the roller thus damaged will have to be reground, which is an expensive operation causing interruptions in production.

In the foregoing, only a few problems have been mentioned by way of example, but in practice there are considerably more reactions and occurrences to be watched and monitored that lead to quality problems. As many of these reactions and occurrences as possible are monitored and watched by using different sensors and measuring devices 41 placed at suitable points in the papermaking process.

In the solution illustrated in FIG. 3, for the sake of simplicity, integrated communication means 2a or, if necessary, detached communication means 2 are placed at only four points, i.e. in the pulp section 31, on the wire 33 and at the output end of the coating station 35 and in conjunction with the intermediate calender 36. The point of placement is not decisive in itself, because the connection may also be wireless, but in most cases the connection is implemented in a wired manner. In each communication means 2, 2a, the inputs of the algorithm module 21 are connected to sensors and measuring devices 41 monitoring the process in the apparatus, and correspondingly the outputs are connected to regulating units of the apparatus, to the control room, etc. to enable the process to be controlled and regulated in accordance with the instructions given by the algorithm module 21. In addition, the algorithm module 21 has suitable inbuilt algorithms which, upon connection of the communication means 2, 2a, identify the most essential characteristics and basic functions of the operating system of the paper machine 28. In case any one of the basic functions is not in order at the moment of connection, the communication means 2, 2a has been arranged to immediately establish connection to the data system associated with the paper machine 28 to unravel and eliminate the problem.

Using the arrangement of the invention, the papermaking process in the paper machine 28 is controlled as an entity, not just one sub-area at a time. as in prior-art solutions. The control of the entity is implemented by employing transparency, which is enabled by the shared memory storage 22 and hologrammatic model storage 24 of the communication means 2, 2a. Thus, the overall situation consisting of signals proceeding from different scattered locations has been arranged to be visible in an assembled, parallel and multi-channel manner simultaneously in all the communication means 2, 2a placed at different points in the process. In addition, via the communication means 2, 2a there is provided either a wired or a wireless connection to required auxiliary devices, such as computers and/or database machines 42 and semantic data storages 43. Similarly, via the communication means 2, 2a is available a wireless UWB connection to any required party, e.g. an expert or expert group having a good knowledge of the paper machine 28 in question, that has the aforesaid communication means 2 at his/her disposal and that has been incorporated with appropriate safety measures as a party involved in the process concerned.

Fitted in the local memory storage 23 of the communication means 2, 2a and in the learning algorithm module 25 is a role-based identification system needed in the arrangement to identify e.g. the point of origin of given data in the papermaking process. By virtue of the learning algorithm module 25 and external sources used, such as semantic data storages 43, the arrangement of the invention used in the papermaking process, which arrangement can be called non-linearity controller of the papermaking process, is self-learning and self-adjusting and it can perform the required steps for allocation of non-linearity occurrences and process control and adjustment independently, quickly and reliably. In addition, as mentioned above, data transfer and processing in the arrangement are implemented by applying grid processing via the grid module 17 provided in the communication means 2, 2a.

As additional features, means for identification of the operator of the apparatus and e.g. a smell detector, which makes it possible to analyze the operator's alveolar air and thus to verify his/her working condition, can be easily connected to the arrangement via the communication means 2, 2a. For example, if the smell detector detects the presence of alcohol in the alveolar air, then the arrangement will not allow the operator in question to operate the paper machine.

By applying the arrangement of the invention, it is possible to control, regulate and manage any process corresponding to or resembling the above-described process. According to the same analogy, the arrangement of the invention can be used to monitor, control, regulate and manage e.g. an innovation process from the conception of an idea to standard industrial production and management of the life cycle of products and to consistent development of new products. FIG. 4 is a simplified and diagrammatic representation or an embodiment of the arrangement of the invention in the implementation of an innovation process. For all parties 46-55 involved in this process and acting in different roles in different situations, a connection to the process is provided via communication means 2. Those parties can join the process at different times and work separately in their own environments. In practice, the aforesaid parties 46-55 exist all the time from the moment of their inclusion in the arrangement and they act via their communication means 2 in different roles in different processes at the same time and in a parallel manner, just like in the above-described papermaking process the communication means 2, 2a placed to control, monitor and regulate different points work at the same time and in a parallel manner in different roles depending on their placement, being able to see the entire control process as a single entity. In the processing of a new invention, the parties 46-55 join when necessary, depending on the situation.

The device allowing the use of the required operating system may be a smartphone 8 provided with a UWB connector, a PDA device or e.g. a computer 4, 5. Moreover, the device may vary depending on the situation where it is used. The essential thing is the communication means 2, through which the connection to and involvement in the process at different stages is implemented. As stated earlier, the communication means 2 allows wireless connection e.g. to a UWB network 45, to which are also connected various data processing facilities corresponding to devices 3-12, which are here presented as computers 44 interconnected to form an entity permitting grid processing. In addition, from the entire aforesaid arrangement, connection is provided to one or more databases and semantic data storages 43 so as to permit communication with one or more of the aforesaid databases and semantic data storages 43 via all the communication means 2, 2a comprised in the arrangement.

An innovation process proceeds e.g. as follows: An inventor 46 conceives an idea that he/she wishes to develop further and perhaps also to protect e.g. by a patent. He/she has previously acquired a communication means according to the invention and registered in the arrangement and his/her identification data have been stored into the arrangement. He/she can act in many different roles in the arrangement, but now he/she is acting expressly as an inventor, at least to begin with. He may now connect his/her communication means 2 to a suitable device, e.g. a smartphone 8, and check the databases and semantic data storages 43 comprised in the arrangement to determine how far his/her invention is utilizable and what chances it has of being made use of. The arrangement comprises in-built means for examining at an early stage of an invention whether the invention is possible at all and e.g. whether it is sensible enough to be implemented in a commercial sense. Having obtained e.g. from a semantic data storage 43 comprised in the arrangement information to the effect that the invention is sufficiently developable, he/she presents his/her invention to the arrangement. At this point he/she may also act in the role of presenter 47, or the presenter 47 may be another person having joined the arrangement. The arrangement likewise comprises in-built means for modeling the solution of the invention so as to render it presentable. Before the presentation of the idea, the arrangement sees to it that the required agreements relating to the processing of the idea, such as secrecy agreements etc., have been appropriately made. Algorithms and means associated with this function are contained in the databases and semantic data storages 43 of the arrangement. The arrangement takes care that relevant agreements are made at all required stages of the entire innovation process.

After the presentation, the next party dealing with invention is a person in the role of an evaluator 48, to whom the arrangement, the inventor or the presenter sends a message e.g. by electronic mail saying that the invention in question should be evaluated. In practice, there are several persons having joined the arrangement who act in the role of evaluator and who play the role of an evaluator in different projects at different stages. The evaluator 48 evaluates at least the inventiveness and suitable possibilities of utilization of the invention.

After the evaluation, a person playing the role of a valuer 49 is engaged in the innovation process. In some cases, the valuer and the evaluator may be the same person. The information needed for the engagement is obtained e.g. by one of the methods discussed above. The valuer 49 calculates a current annual value for the idea. The valuer 49 may be one person or e.g. a group of experts having extensive knowledge as to how to calculate the real value of ideas.

In connection with or after the determination of the value of the idea, the arrangement engages an insurer 50, who insures the utility of the idea on the basis of the value of the idea. After the idea has been insured for its calculated value, the idea is presented to one or more investors 51, who invest a desired contribution in the development of the idea and are granted by the insurer 50 an insurance coverage for their investment.

The arrangement may also include a mentor 53, who makes his/her own contribution to the development of the idea, and an entrepreneur 54, who implements the commercialization of the idea in cooperation with service providers and possible partners 55 having joined the arrangement. The innovation process discussed as an example in the arrangement of the invention is not terminated at the entrepreneur, but the process lives on and changes all the time due to the contributions of the aforesaid parties 46-55 and the arrangement. Once the product based on the original idea has been introduced on the market, further development of the product is started after some time and is implemented in the arrangement on the principles described above. Additional parallel activities are development of the entrepreneur's 54 business thus started as well as many other required development projects.

All the above-mentioned parties 46-55 have a connection to the arrangement, and at the same time they have common data allowed by their roles in the transparent shared memory 22 of their communication means and in the hologrammatic model storage 24. Thus, the overall entity of the whole innovation process is easy to manage and everyone can see in what state the process is. In addition, the arrangement comprises means giving it a self-learning capability as stated above. Therefore, all processes carried through improve the knowledge stored in the arrangement and thus continuously teach the arrangement. Thus, the treatment and refinement of new processes may be faster and better in quality than earlier processes.

The use of the arrangement of the invention for carrying through an innovation process as described above by way of example sets the inventor 46 free to do exactly what he/she can do best. Having conceived a developable idea, the inventor 46 need not be alone taking care of the financing, protection and development of his/her invention. It is sufficient that his/her invention is developable enough and has been presented to the arrangement. The arrangement helps take care of the rest.

The above description deals with only two processes in which the arrangement of the invention and the associated communication means 2, 2a are usable. In practice, there are various other analogous or nearly analogous processes. A circumstance common to them all is that a communication means 2, 2a according to the invention has been arranged to take care of protected and, where necessary, verified data transfer, said communication means comprising at least means for receiving and transmitting data and appropriate algorithms for implementing the functions for which the communication means 2, 2a has been fitted. Moreover, the communication means 2, 2a have been adapted to establish connection to a network permitting grid processing, in which network are available for use at least semantic data storages 43 and various data-bases as well as computers or processors providing computing power when needed. Other common features of the arrangement include role-based operation and a transparency permitting real-time distribution of data to the parties involved and therefore decentralized, parallel and multi-channel processing of data of different formats, thus making it possible to monitor, supervise, regulate and control the processes in a comprehensive manner.

It is obvious to a person skilled in the art that different embodiments of the invention are not exclusively limited to the examples described above, but that they may be varied within the scope of the claims presented below. Thus, for example, the communication means may be provided with facilities and means different from those described above.

1-10. (canceled)

11. Knowledge-intensive arrangement (1) for handling of scattered data, said arrangement comprising at least devices (3-12, 44), interconnected via a network and provided with different properties and operating systems, and a communication means (2, 2a) connectable to at least one of the devices (3-12, 44), said communication means (2, 2a) being provided with a communication element (14) for setting up a connection and adapted to identify the role or user of the communication means (2, 2a) and, upon acceptable accomplishment of identification, to establish a verified and protected connection via the communication means (2, 2a) to the other devices (3-12, 44) connected to the arrangement (1), characterized in that the communication means (2, 2a) contains a user identification module (18) protected by at least one or more firewalls (15, 20a-20c), and an algorithm module (21), said algorithm module (21) being adapted at least to verify the user identification module (18), and that the communication means (2, 2a) contains a grid module (17) protected by at least one or more firewalls (15, 20a-20c), said grid module (17) being arranged to use distributed grid processing in data transfer and processing.

12. Arrangement (1) according to claim 11, characterized in that the communication element (14) of the communication means (2, 2a) is an element forming a wireless UWB connection.

13. Arrangement (1) according to claim 11, characterized in that the algorithm module (21) has been adapted to verify the user identification module (18) in such manler that. via the algorithm module (21), all existing standards and corresponding definitions are interconnected so that they are mutually compatible and controlled by the algorithm module (21).

14. Arrangement (1) according to claim 11, characterized in that the communication means (2, 2a) contains one or more of the following facilities or functions, protected by one or more firewalls (15, 20a-20c): facilities provided in the firewall (15) for performing XIP identification and IP tunneling; a localization element (16); facilities in the user identification module (18) for performing biometric identification, presence detection and personification; a virtual FLASH component (19); a shared data storage (22) for cooperative use, a local data storage (23), a hologrammatic model storage (24) and a learning algorithm module (25).

15. Arrangement (1) according to claim 11, characterized in that the communication means (2, 2a) contains facilities for reading electronic mail and mail attachments from an electronic mail server while protected against viruses and for sending electronic mail with attachments to an electronic mail server while protected against viruses, and that the communication means (2, 2a) contains facilities for storing electronic mail read from the server and for reading such mail in offline mode.

16. Arrangement (1) according to claim 11, characterized in that, to monitor, regulate and control the process, at least the following steps are performed via the communication means (2, 2a):
identification of the role of the communication means (2, 2a);
allowing and implementing the set-up of connections to semantic data storages (43) and databases comprised in the arrangement (1) via communication means (2, 2a) involved in the process;
parallel, multi-channel, real-time and interactive distribution of information concerning the process steps to be monitored, regulated and controlled to communication means (2, 2a) involved in the process.

17. Arrangement (1) according to claim 16, characterized in that, in the identification of the role of the communication means (2, 2a), the role is that of the user of a detached communication means (2) or a role related to the location and function of the communication means (2a), and that the algorithm module (21) of the communication means (2, 2a) contains means for performing the functions of each role.

18. Arrangement (1) according to claim 16, characterized in that one or more communication means (2, 2a) are connected to different stages in the papermaking process in a process apparatus, such as a paper machine, to monitor, observe, control and regulate the process in such manner that the scattered sensor and measurement data obtained in different formats from the production process is passed to be handled by the algorithm module (21) of the communication means (2, 2a) monitoring each point in the process, and that all data to be handled is distributed to all communication means involved so as to have the data processed in a parallel and substantially simultaneous (2, 2a) manner, and that the algorithm modules (21) of the communication means (2, 2a) are provided with means for giving instructions and changes to the process.
